(19) United States
(12) Patent Application Publication
(10) Pub. No.: US 2015/0145319 A1
(43) Pub. Date: May 28, 2015

(54) AXLE DEVICE FOR BICYCLES

(71) Applicant: Christian Leuenberger, Frenkendorf (CH)

(72) Inventor: Christian Leuenberger, Frenkendorf (CH)

(73) Assignees: Christian LEUENBERGER, CH-4402 Frenkendorf (CH); Patrik VÖGTLI, CH-4144 Arlesheim (CH)

(21) Appl. No.: 14/403,617

(22) PCT Filed: May 17, 2013
(86) PCT No.: PCT/EP2013/060292

§ 371 Date: Nov. 25, 2014

(30) Foreign Application Priority Data
Jun. 4, 2012 (CH) CH00774/12

(51) Int. Cl. B62K 25/02

(52) U.S. Cl. CPC B62K 25/02
USPC 301/124.2

(57) ABSTRACT

An axle device for inserting into passage openings (5, 6) of a bicycle fork or of a bicycle frame (7) and for accommodating a bicycle hub, comprising a hollow cylinder (1), a tension rod (2) having a quick tensioning device (3), and a retaining device (4), wherein the tension rod (2) extends coaxially along the hollow cylinder (1), and wherein the tension rod (2) and the hollow cylinder (1) can be moved relative to one another and can be rotated about the axis (A). The retaining device (4) comprises an insert element (41) that can be inserted into one of the passage openings (5, 6) such as to be detached from the tension rod (2), and the tension rod (2) has a fastening section (21) at one end, which fastening section can be brought into engagement with the insert element (41) when the axle device is installed.

### BACKGROUND OF THE INVENTION

1. Field of the Invention

The invention relates to an axle device for insertion into passage openings of a bicycle fork or of a bicycle frame and for receiving a bicycle hub, comprising a hollow cylinder, a tension rod with a quick-action clamping device, and a retention device, wherein the tension rod extends coaxially along the hollow cylinder, and wherein the tension rod and the hollow cylinder are displaceable relative to one another in an axial direction and are rotatable relative to one another about the axis.

2. Discussion of Related Art

To receive bicycle hubs, bicycle forks and bicycle frames have axle devices which are mounted fixedly on ends of the bicycle fork (front wheel axle) or of the bicycle frame (rear wheel axle). In particular in the case of bicycles that are subjected to high loads, for example mountain bikes, use is often made of quick-release axles. Quick-release axles are passed through the passage openings at the ends of the fork or of the frame and through the corresponding front or rear wheel hub.

For example, a quick-release axle is known which is composed of a metallic hollow cylinder which, on one end, has an external thread and, on the other end, has a spreader device. For installation, the quick-release axle is passed by way of the externally threaded end through the first passage opening and the hub and is screwed into an internal thread of the second passage opening as far as a stop. An internal thread of said type is provided as standard in many bicycle forks and frames. Subsequently, by means of the spreader device, that end of the quick-release axle which is arranged in the first passage opening is widened in diameter and, in the process, is fixedly braced. The hollow cylinder of the quick-release axle firstly absorbs the clamping force in the axial direction for the fixing of the axle and secondly absorbs the force acting perpendicularly on the axle owing to the weight of the bicycle and of the rider and the loads corresponding to the field of use, for example mountain biking. A problem with said quick-release axle is that, when inserted with the external thread, it is normally screwed all the way to the end of the external thread flight, and therefore becomes jammed and seizes. After a certain period of time, the quick-release axle can be removed again only with great difficulty and with high expenditure of force. Furthermore, fine adjustment of the axial clamping force and simultaneous optimum orientation of the clamping lever of the spreader device along the bicycle fork or the bicycle frame is scarcely possible.

DE 102008012573 has disclosed an axle device for insertion into passage openings of a bicycle fork or of a bicycle frame and for receiving a bicycle hub. The axle device comprises a hollow cylinder, which serves as the axle per se. Furthermore, said axle device comprises, coaxially with respect to the hollow cylinder, a tension rod which is equipped, on one side, with a quick-action clamping device and, on the other side, with an expandable, multi-part retention device. Actuation of the quick-action clamping device causes the tension rod to be displaced relative to the hollow cylinder. In this way, the retention device is blocked in an expanded state and pressed against the boundary of the passage opening. To remove the axle device, it is firstly necessary, at one side, for the quick-action clamping device to be released. Subsequently, from the other side, the retention device must be made smaller in diameter again and pushed in the direction of the hub until it is pushed into the passage opening. Only then can the axle device be pulled completely out of the hub and out of the passage openings. It is also a disadvantage that dirt can easily accumulate in the expanded retention device, which dirt additionally impedes a removal of the axle device because the diameter of the retention device can no longer be readily decreased.

### SUMMARY OF THE INVENTION

It is an object of the invention to specify an axle device of the type mentioned in the introduction which is simple and lightweight in terms of construction, which is easy to operate and which can be released and removed from one side. Furthermore, said axle device should be less susceptible to dirt accumulation. Furthermore, the axle device should have the lowest possible weight.

Said object is achieved by means of the features of claim 1. The axle device according to the invention for insertion into passage openings of a bicycle fork or of a bicycle frame and for receiving a bicycle hub comprises a hollow cylinder, a tension rod with a quick-action clamping device, and a retention device. The tension rod extends coaxially along the hollow cylinder. The tension rod and the hollow cylinder are displaceable relative to one another in an axial direction and are rotatable relative to one another about the axis. The retention device comprises an insert element which is designed such that it, detached from the tension rod, can be inserted into one of the passage openings of a bicycle fork or of a bicycle frame. The tension rod has, on one end, a fastening section which can be engaged with the insert element inserted in the passage opening when the axle device, or the tension rod together with the hollow cylinder, is inserted.

For the installation of the axle device according to the invention, the insert element of the retention device is inserted into one of the two passage openings of a bicycle fork or of a bicycle frame. Subsequently, the tension rod together with the hollow cylinder can be passed through the other passage opening and through a bicycle hub. Here, the tension rod, for example by being rotated about its axis, is engaged with the insert element of the retention device, and the axle device is fixedly braced by means of the quick-action clamping device. For the removal process, the quick-action clamping device is opened, and the tension rod can, for example by being rotated about its axis, be released from the insert element and pulled together with the hollow cylinder out of the bicycle hub. Here, the insert element may remain in the passage opening and does not need to be removed, such that the insertion and removal of the axle device can be performed easily from one side, and the quick-action clamping lever can, in the respectively preset and desired position, be moved into an end position without having to be reset or readjusted every time. The insert element may for example already be installed or integrated in the passage opening, for example in the form of a constituent part of the bicycle fork or of the bicycle frame.

The quick-action clamping device on one end of the tension rod is preferably a conventional quick-action clamping device with a quick-action clamping lever, an eccentric and a thrust piece, wherein the thrust piece has a larger diameter than the passage openings such that it can be brought to bear against the edge of one of the passage openings. The other end of the tension rod is connected to the retention device in the other passage opening. By actuation of the quick-action clamping device, the two ends of the bicycle fork or of the bicycle frame with the passage openings are pulled toward one another, and the axle device is fixedly braced.

In the case of the axle device according to the invention, the clamping or bracing force in the axial direction is absorbed by the tension rod. The force perpendicular to the axle, arising from the weight of the bicycle and of the rider and the loads acting on the quick-release axle during riding, is absorbed by the hollow cylinder.

Preferred embodiments of the invention are specified in the dependent claims.

In a preferred embodiment of the invention, the insert element can, for fine adjustment of the quick-action clamping device in an installed state, be rotated about the axis. In this way, by means of the quick-action clamping device, it is possible to realize an optimum clamping force, and a clamping lever of the quick-action clamping device can in this case always be oriented in the desired direction, for example along the bicycle fork. To rotate the insert element for fine adjustment purposes, said insert element may have a hexagonal socket or the like, or an external section which projects out of the passage opening and which can be easily manipulated at any time.

In a further preferred embodiment of the axle device according to the invention, the insert element has an external thread and can be screwed by way of the external thread into one of the passage openings of a bicycle fork or of a bicycle frame and, in the inserted state, is rotatable about the axis in order to ensure the fine adjustment.

In a further preferred embodiment of the axle device according to the invention, the insert element is provided not with an external thread but with a spring channel groove, and can be fixedly inserted, in a passage opening of the bicycle fork or the bicycle frame, into a corresponding guide groove so as to be fixed in an axial direction of the axle device. An insert element of said type is freely rotatable about the axis of the axle device and is simultaneously secured so as to be prevented from falling out when the tension rod is not inserted.

It is preferable for the fastening section of the tension rod to be a threaded section and for the insert element to have an internal thread into which the threaded section of the tension rod can be screwed and engaged. The insert element is preferably of unipartite form.

In a further preferred embodiment of the axle device according to the invention, the insert element has an inner section and an outer section, wherein said insert element can be inserted by way of the inner section into one of the axle receiving openings of a bicycle fork or of a bicycle frame, and the outer section protrudes out of the passage opening such that the insert element can be easily rotated for fine adjustment purposes. The insert element is preferably dimensioned, in an axial direction, so as to be arranged only in a sub-region of the passage opening, such that the hollow cylinder can be inserted into the other sub-region of the passage opening in order to absorb the load of the bicycle.

In a further preferred embodiment of the axle device according to the invention, the retention device has a securing means which prevents the insert element from falling out of the passage opening, specifically when the tension rod is not connected to the insert element. For example, an outer section of the insert element may have a larger diameter than the passage opening, wherein, on the side facing toward the passage opening, there is arranged an elastic element, for example a rubber ring, for preventing self-loosening of the insert element and thus preventing said insert element from falling out when the tension rod is not inserted. Here, the elastic element, as before, permits a rotation of the insert element for fine adjustment purposes.

In a further preferred embodiment of the axle device according to the invention, the tension rod has a driver which limits the displaceability of the hollow cylinder in an axial direction relative to the tension rod, such that, when the tension rod is pulled out of a bicycle hub, the hollow cylinder is pulled with it. The driver is preferably arranged in the region within the hollow cylinder. It is furthermore preferable for the driver to be arranged in the vicinity of the quick-action clamping device, such that the tension rod is displaced by only a few millimeters relative to the hollow cylinder during the pulling-out process. Accordingly, the tension rod exhibits play of a few millimeters, preferably 3-4 mm, relative to the hollow cylinder in the axial direction. As the tension rod is pulled out, the driver can abut against an internal projection of the hollow cylinder or against the closure element, described further below, with guide opening. The driver may be a nut, ring or sleeve that is fixed to the tension rod.

In a further preferred embodiment of the axle device according to the invention, the hollow cylinder has, at both ends, a respective closure element with a guide opening for the tension rod, and the closure elements are preferably each fixedly connected to the ends of the hollow cylinder. The closure elements preferably have a hollow cylindrical region which, for additional reinforcement of the ends of the hollow cylinder, each extend into the hollow cylinder.

The closure elements are for example tubular elements which, on one side, are closed off with the exception of the guide openings and which can be inserted into the hollow cylinder at both sides. The closure elements may have an encircling flange with the same diameter as the hollow cylinder. On the side of the retention device, the closure element may additionally have an outer section which can be inserted with an accurate fit into a fitting seat of the insert element.

The hollow cylinder is preferably manufactured from a fiber-reinforced composite material, in particular a carbon fiber-reinforced composite material, from a light metal, in particular aluminum or titanium, or from ceramic composite materials. The two closure elements are preferably manufactured from plastics or light metal, in particular aluminum or titanium. The closure elements may for example be in the form of injection molded parts.

In a further preferred embodiment of the axle device according to the invention, the closure element at the side facing toward the insert element has a cylindrical section which can be plugged into a hollow cylindrical section of the closure element.

### BRIEF DESCRIPTION OF THE DRAWINGS

The invention will be explained in more detail below on the basis of exemplary embodiments and in conjunction with the drawing, in which:

FIG. 1 shows an embodiment of the axle device according to the invention in a sectional illustration; and

FIG. 2 shows a further embodiment of the axle device according to the invention in a sectional illustration.

### DETAILED DESCRIPTION OF THE INVENTION

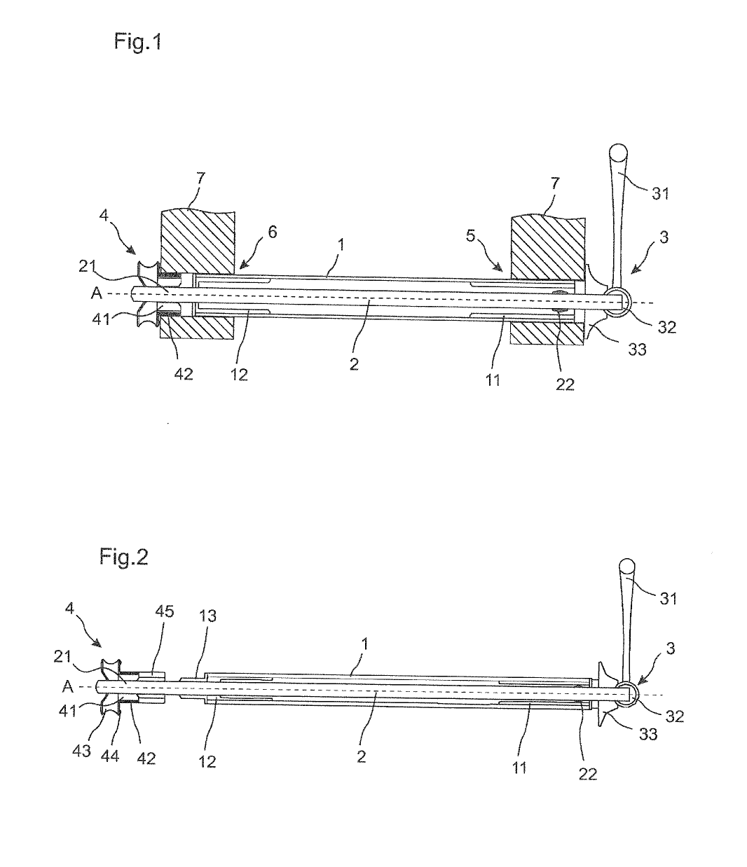

FIG. 1 shows, in a sectional illustration, an embodiment of an axle device according to the invention for insertion into passage openings 5, 6 of a bicycle fork or of a bicycle frame 7 and for receiving a bicycle hub (not shown). FIG. 1 shows the axle device in the installed state. The axle device comprises a tension rod 2 which extends coaxially along a hollow cylinder 1 and which projects out of the hollow cylinder 1 at both sides. The tension rod 2 and the hollow cylinder 1 are displaceable relative to one another in an axial direction and are rotatable relative to one another about the axis A. On one end of the tension rod 2 there is arranged a quick-action clamping device 3 with a quick-action clamping lever 31, an eccentric 32 and a thrust piece 33, wherein the thrust piece 33 has a larger diameter than the passage openings 5, 6, such that said thrust piece can be brought to bear against the edge of one of the passage openings 5. The other end of the tension rod 2 has a fastening section 21 which is in the form of a threaded section. The passage opening 6 situated opposite the quick-action clamping device has an internal thread into which an insert element 41 is screwed by way of an external thread 42. The insert element 41 furthermore has an internal thread into which the tension rod 2 is screwed by way of the threaded section 21. By actuation of the quick-action clamping device 3, the two ends of the bicycle fork or of the bicycle frame 7 with the passage openings 5, 6 are pushed toward one another, and the axle device is fixedly braced in this way.

The hollow cylinder 1 has an external diameter substantially corresponding to the internal diameter of the passage openings 5, 6, and is inserted into both passage openings 5, 6 to an adequate extent such that the bicycle fork or the bicycle frame 7 is mounted on the hollow cylinder 1 of the axle device. The diameter of the passage opening 5, 6 is typically 15 mm in the case of a front wheel fork and 12 mm in the case of a rear wheel fork. The hollow cylinder 1 is produced from a carbon fiber-reinforced composite material (carbon fiber-reinforced plastic, CFRP), though may also be manufactured from other materials such as light metal, in particular aluminum or titanium, or ceramic materials.

The hollow cylinder 1 is closed off at both ends by way of closure elements 11, 12, wherein the closure elements 11, 12 have guide openings for the tension rod 2. The closure elements 11, 12 are for example manufactured from light metal, such as aluminum or titanium, or from plastic. The closure elements 11, 12 are hollow cylinders which are closed off on one side and which are inserted by way of a cylinder section into the hollow cylinder 1 and are fixedly connected to the hollow cylinder 1. Accordingly, the external diameter of the cylinder section of the closure elements 11, 12 corresponds to the internal diameter of the hollow cylinder 1. At the closed-off side, the closure element 11, 12 may have an encircling flange whose diameter corresponds to the external diameter of the hollow cylinder 1. The cylinder section of the closure elements 11, 12 provides additional reinforcement for the two ends of the hollow cylinder 1.

Furthermore, a driver 22 is fastened to the tension rod 2, preferably in the region of the closure element 11 at the quick-action clamping means side, which driver limits the relative displaceability of the hollow cylinder 1 relative to the tension rod 2 in an axial direction by abutting against the boundary of the guide opening of the closure element 11 at the quick-action clamping means side. Here, as the tension rod 2 is pulled out of the passage openings 5, 6 and the bicycle hub, the hollow cylinder 1 is pulled with it. Ideally, the tension rod 2 exhibits play of approximately 3-4 mm relative to the hollow cylinder 1 in the axial direction.

The insert element 41 of the retention device 4 is inserted into the passage opening 6 such that it can, for fine adjustment of the quick-action clamping device 3 in the inserted state, be rotated about the axis A. In FIG. 1, the insert element 41 has an outer region 43 which, for fine adjustment purposes, can be gripped by hand or engaged using a suitable tool. The outer region 43 has a larger diameter than the passage opening 6. To secure the insert element 41 so as to prevent it from inadvertently falling out (when the tension rod has been unscrewed), a rubber ring 44 is arranged between the outer region 43 and the passage opening 6.

The retention device 4 for the passage opening 6 may either be an individual component or may be directly integrated into the bicycle fork or the bicycle frame 7, which is then installed by the fork or frame manufacturers.

FIG. 2 shows, in a sectional illustration, a further embodiment of an axle device according to the invention for insertion into passage openings 5, 6 of a bicycle fork or of a bicycle frame 7 and for receiving a bicycle hub (not shown). By contrast to the embodiment of FIG. 1, the closure element 12 on that side of the hollow cylinder 1 which faces toward the retention device 4 has a cylindrical section 13 projecting out of the hollow cylinder 1. The cylindrical section 13 has a smaller external diameter than the hollow cylinder 1. The insert element 41 has, at the side facing toward the closure element 12, a hollow cylindrical section 45. The hollow cylindrical section 45 has an internal diameter which corresponds to the external diameter of the cylindrical section 13 and forms a fitting seat for the cylindrical section 13. FIG. 2 shows the hollow cylindrical section 45 and the cylindrical section 13 in a state in which they have not been plugged together. During the installation of the axle device, the cylindrical section 13 is plugged into the hollow cylindrical section 45 in order to transmit the load of the bicycle fork or of the bicycle frame to the hollow cylinder.

1. An axle device for insertion into passage openings (5, 6) of a bicycle fork or of a bicycle frame (7) and for receiving a bicycle hub, the axle device comprising:
a hollow cylinder (1), a tension rod (2) with a quick-action clamping device (3), and a retention device (4), wherein the tension rod (2) extends coaxially along the hollow cylinder (1), and wherein the tension rod (2) and the hollow cylinder (1) are displaceable relative to one another in an axial direction and are rotatable about an axis (A), wherein the retention device (4) comprises an insert element (41) which, when detached from the tension rod (2), can be inserted into one of the passage openings (5, 6) of a bicycle fork or of a bicycle frame, and the tension rod (2) includes, on one end, a fastening section (21) engaged with the insert element (41) when the axle device is inserted.

2. The axle device as claimed in claim 1, wherein the insert element (4) can, for fine adjustment of the quick-action clamping device (3) in an inserted state, be rotated about the axis (A).

3. The axle device as claimed in claim 1, wherein the insert element (41) includes an external thread (42) and can be screwed by way of the external thread (42) into one of the passage openings (5, 6) of a bicycle fork or of a bicycle frame (7) and, in the inserted state, is rotatable about the axis (A).

4. The axle device as claimed in claim 1, wherein the insert element (41) is provided with a spring channel groove and can be inserted into a passage opening (6), provided with a corresponding guide groove, of a bicycle fork or of a bicycle frame (7), wherein the insert element (41), in the inserted state, is rotatable about the axis (A).

5. The axle device as claimed in claim 1, wherein the fastening section (21) of the tension rod (2) comprises a threaded section, and the insert element (41) has an internal thread into which the threaded section (21) of the tension rod (2) can be screwed and engaged.

6. The axle device as claimed in claim 1, wherein the insert element (41) includes an inner section and an outer section (43), wherein said insert element can be inserted by way of the inner section into one of the axle receiving openings (5, 6) of a bicycle fork or of a bicycle frame (7), and the outer section (43) protrudes out of the passage opening (5, 6) such that the insert element (41) can be easily rotated for fine adjustment purposes.

7. The axle device as claimed in claim 1, wherein the retention device (4) includes securing means (44) which prevent the insert element (41) from falling out of the passage opening (5, 6).

8. The axle device as claimed in claim 1, wherein the tension rod (2) has includes a driver (22) which limits the displaceability of the hollow cylinder (1) in an axial direction relative to the tension rod (2), such that, when the tension rod (2) is pulled out of a bicycle hub, the hollow cylinder (1) is pulled with it.

9. The axle device as claimed in claim 1, wherein the hollow cylinder (1) includes, at both ends, a respective closure element (11, 12) with a guide opening for the tension rod (2), and the closure elements (11, 12) are preferably each fixedly connected to the ends of the hollow cylinder (1).

10. The axle device as claimed in claim 9, wherein the closure elements (11, 12) include a hollow cylindrical region which, for additional reinforcement of the ends of the hollow cylinder (1), each extend into the hollow cylinder (1).

11. The axle device as claimed in claim 9, wherein the closure element (12) at a side facing toward the insert element (41) includes a cylindrical section (13) which can be plugged into a hollow cylindrical section (45) of the closure element (12).
